(19) United States
(12) Patent Application Publication
(10) Pub. No.: US 2008/0144650 A1
(43) Pub. Date: Jun. 19, 2008

(54) APPARATUS FOR CONTACTLESS TRANSMISSION OF DATA FROM A MEMORY

(75) Inventors: Robin Boch, Munich (DE); Gerd Dirscherl, Munich (DE); Berndt Gammel, Markt-Schwaben (DE); Josef Riegebauer, llz (AT); Till Winteler, Munich (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 11/954,085

(22) Filed: Dec. 11, 2007

(30) Foreign Application Priority Data
Dec. 19, 2006 (DE) 10 2006 060 080.0

(51) Int. Cl. H04J 15/00

(52) U.S. Cl. 370/464

(57) ABSTRACT

Apparatus for contactless data transmission according to a predetermined transmission protocol providing control information and payload for a data transmission, with a near field communicator and an interface connected to the near field communicator, the interface being operative to exchange, using a first protocol, data with the near field communicator for the contactless transmission. In this context, the first protocol provides a transmission of control information and payload, the payload of the first protocol including the control information and the payload of the predetermined protocol. The apparatus further includes a module coupled to the interface and being operative to exchange, using the payload of the first protocol, the control information and the payload of the predetermined transmission protocol for the data exchanged contactlessly by the near field communicator.

### CROSS-REFERENCE TO RELATED APPLICATION

This application claims priority from German Patent Application No. 102006060080.0, which was filed on Dec. 19, 2006, and is incorporated herein in its entirety by reference.

### TECHNICAL FIELD

The present invention relates to an apparatus for contactless data transmission from a memory, e.g. from a single-chip controller card or a memory card, such as may be found in the field of RFID applications and SIM card applications.

### BACKGROUND

In the area of smartcards or memory cards, a plurality of NFC-suitable devices (NFC=near field communication) may be found in the conventional technique. Contactless subsystems which are capable of emulating contactless chip card applications may be frequently found especially in mobile devices such as mobile phones, PDAs (PDA=personal digital assistant) etc. In principle, these subsystems may comprise an NFC modem and one or more secure elements, such as a SIM card (SIM=subscriber identity module), connected via a data interface.

Mifare is one widespread contactless-card system available in different embodiments such as Mifare Classic, Mifare Ultralight etc. in the field of the conventional technique. Mifare specifies a very special protocol which enables transactions such as authentication, reading and writing etc. of memory regions on a contactless card. Mifare is a proprietary protocol outside the conventional standards ISO 14443-3 or ISO 14443-4, which specify the communication for so-called RFID cards. Mifare mechanisms, such as the Mifare authentication method, are not defined within the framework of the ISO 1443 specifications.

### SUMMARY

According to one embodiment, an embodiment of the present invention includes an apparatus for a contactless data transmission according to a predetermined transmission protocol providing control information and payload for a data transmission, with a near field communication means and an interface connected to the near field communication means, the interface being operative to provide, using a first protocol, data to the near field communication means for the contactless transmission or to obtain, using the first protocol, data received contactlessly from the near field communication means. In this process, the first protocol provides a transmission of control information and payload, with the payload of the first protocol including the control information and the payload of the predetermined protocol. The apparatus further includes a means connected to the interface and being operative to obtain, from the payload of the first protocol, the control information and payload of the predetermined transmission protocol for the data received contactlessly from the near field communication means or to introduce, into the first protocol, the control information and the payload of the predetermined transmission protocol for the data to be transmitted contactlessly from the near field communication means.

### BRIEF DESCRIPTION OF THE DRAWINGS

Embodiments of the present invention will be detailed subsequently referring to the appended drawings, in which:

FIG. 1 is a conventional architecture of a chip card application;

FIG. 2 is an embodiment of an apparatus for contactless data transmission;

FIG. 3 is an illustration of a data packet in one embodiment;

FIG. 4 is a further embodiment of a data transmission circuit for contactless data transmission;

FIG. 5 is an embodiment of a data portion of a predetermined transmission protocol; and

FIG. 6 is an embodiment of a data portion of a first protocol.

### DETAILED DESCRIPTION

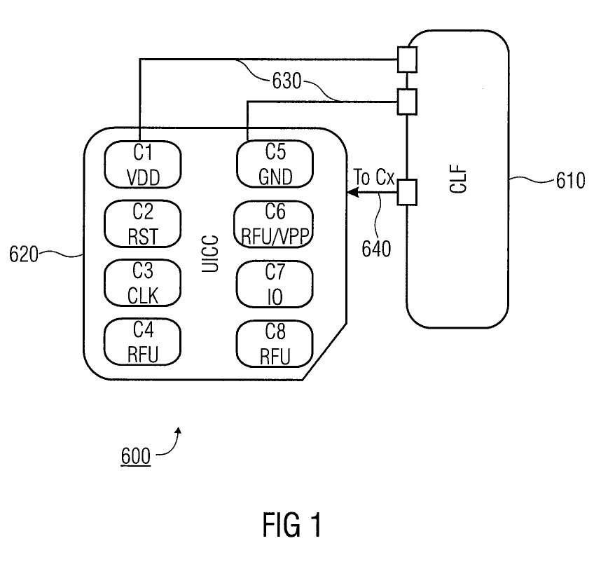

FIG. 1 illustrates a contactless subsystem 600. FIG. 1 shows a CLF 610 (CLF=connectionless front end) connected to a secure element 620. In FIG. 1, the secure element 620 is, by way of example, realized as an UICC (UICC=universal integrated circuit card). Both the CLF 610 and the secure element 620 have, apart from an energy supply 630, a data connection 640. The CLF 610 represents an NFC modem in FIG. 1. The data connection 640, also referred to as “ToCx” in FIG. 1, can be realized by a single line. For this case, the single wire protocol (SWP) may be deployed.

An architecture as illustrated in FIG. 1 is capable of emulating a classical contactless single-chip controller card or a memory card, which is sometimes also referred to as a so-called “Card Emulation Mode”.

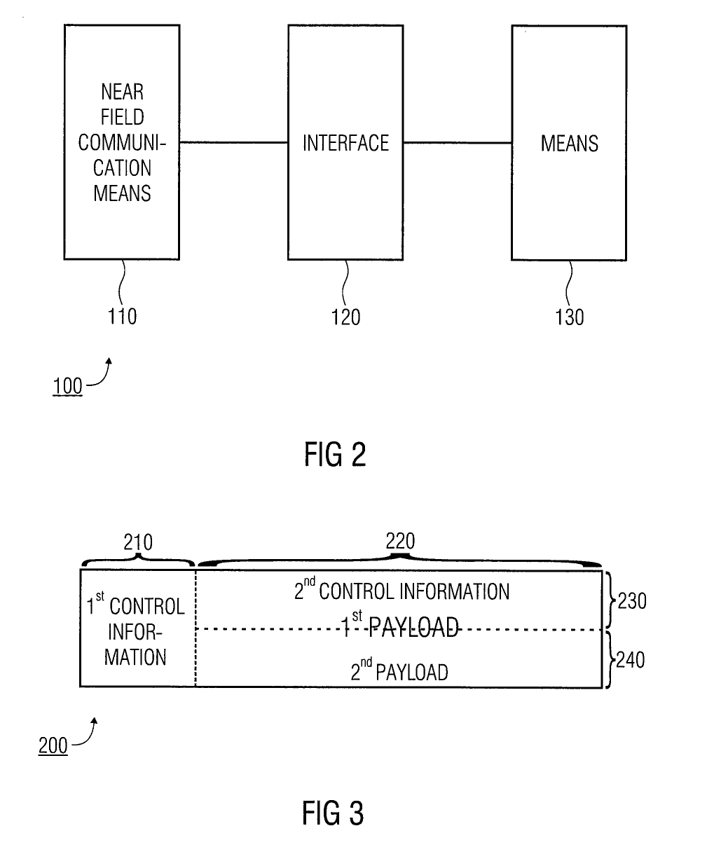

FIG. 2 shows an apparatus 100 for contactless data transmission according to a predetermined transmission protocol providing control information and payload for a data transmission. The apparatus 100 includes a near field communication means 110, an interface 120 and a means 130. The interface 120 is connected to the near field communication means 110 and is operative to provide, using a first protocol, data to the near field communication means 110 for the contactless transmission or to obtain, using the first protocol, data received contactlessly from the near field communication means 110.

In this process, the first protocol provides a transmission of control information and payload, with the payload of the first protocol including the control information and the payload of the predetermined protocol. The apparatus 100 further includes the means 130 connected to the interface 120 and being operative to obtain, from the payload of the first protocol, the control information and the payload of the predetermined transmission protocol for the data received contactlessly from the near field communication means 110 or to introduce, into the first protocol, the control information and the payload of the predetermined transmission protocol for the data to be transmitted contactlessly from the near field communication means 110.

In one embodiment, the near field communication means 110 is formed to communicate according to the specifications of ISO 14443-3 or ISO 14443-4. The first protocol may further contain information identifying the payload as control information and payload of the predetermined transmission protocol. For example, the information may be contained in a part of the header of a frame of the first protocol, in a part of the payload or in a prior frame as only payload. In one embodiment, the first protocol is realized by the SWP (single wire protocol) and the predetermined protocol by the Mifare protocol. In this context, the predetermined protocol may include Mifare Classic, Mifare Light or Mifare Ultralight.

In a further embodiment, the near field communication means 110 may include an NFC modem. Further, the apparatus 100 may include a UICC (universal integrated circuit card) in turn comprising the interface 120 and the means 130. In one embodiment, the apparatus 100 may include a UICC receiving data according to the first protocol, and a chip receiving data according to the predetermined protocol, with the UICC and the chip being connected to the near field communication means 110 via the interface 120 and the chip including the means 130. In further embodiments, the UICC may not react upon receipt of data according to the predetermined protocol at the near field communication means 110, which, for example, realizes the case above in which the means 130 is disposed on a chip in parallel to a UICC and the means 130 reacts to the predetermined protocol and the UICC reacts to the first protocol. Further, the UICC may be a SIM card with a memory.

FIG. 3 shows an embodiment of a data packet 200 of the first protocol. The data packet 200 comprises a control information 210 and a payload 220. The control information 230 and the payload 240 of the predetermined transmission protocol are included in the payload 220 of the first protocol.

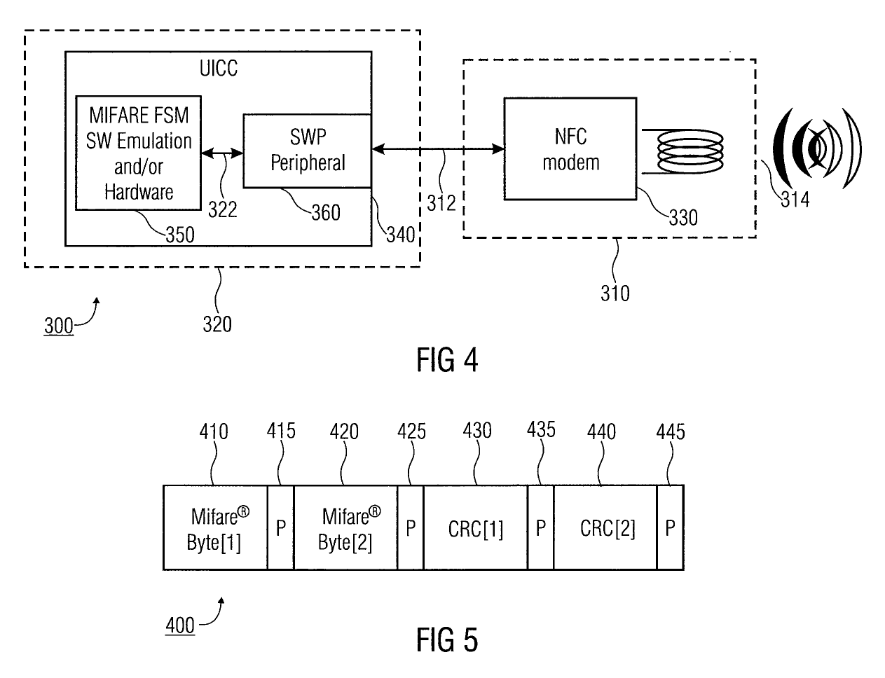

FIG. 4 shows a data transmission circuit 300 with a transceiver module 310, with an interface 312 for a first protocol and an air interface 314. The data transmission circuit 300 further includes a memory module 320 coupled to the interface 312 for the first protocol. In this context, the memory module 320 is formed to obtain, from the payload of the first protocol, control information and payload of the predetermined transmission protocol for data received via the air interface 314 or to introduce, into the first protocol, the control information and the payload of the predetermined transmission protocol for the data to be transmitted via the air interface 314.

In one embodiment of a data transmission circuit 300, the air interface 314 may be formed to function in accordance with ISO 14443-3 or ISO 14443-4. Further, the first protocol may be realized by the SWP (single wire protocol), and the predetermined protocol may be realized by a Mifare protocol. The transceiver module 310 may, in some embodiments, include a NFC modem 330 according to FIG. 4. In further embodiments, the memory module 320 may include a UICC 340 or a SIM card.

In one embodiment according to FIG. 4, the data transmission circuit represents a Mifare emulator 300. In this context, the Mifare emulator 300 includes a NFC modem 330 and an interface 312 connected to the NFC modem. The interface 312 is operative to provide, using the SWP, data to the NFC modem 330 for the contactless transmission or to obtain, using the SWP protocol, data received from the NFC modem 330. The Mifare emulator further includes a UICC 340 coupled to the interface 312 for communication via the SWP and comprising a Mifare FSM 350 (FSM=frame state machine) being operative to obtain, from the payload of the SWP, the Mifare control information and the Mifare payload for the data received from the NFC modem 330 or to introduce, as payload into the SWP, the Mifare control information and the Mifare payload for the data to be transmitted from the NFC modem 330.

In one embodiment, the NFC modem 330 is formed to communicate according to ISO-14443-3 or ISO-14443-4. The Mifare FSM 350 may, via a further interface 322, be connected to a SWP peripheral 360 coordinating the communication via the interface 312 according to the SWP. In this embodiment, the NFC modem 330 and the UICC 340 use SWP as the first protocol. The Mifare FSM 350 may, in some embodiments, support Mifare Classic, Mifare Light or Mifare Ultralight, with similar protocols being conceivable, in principle, in other embodiments, too. Further, the UICC 340 may also be realized by a SIM card.

In a further embodiment, the UICC 340 and the Mifare FSM 350 may be arranged in parallel to thus transmit Mifare data to the UICC 340 and a Mifare FSM 350, for example. In other embodiments, data may also be provided to yet further instances connected in parallel, with only those instances respectively becoming active which are designed for the corresponding communication, i.e. which are compatible with Mifare, for example. In this embodiment, all other instances would not actively participate in the communication.

According to one embodiment, a Mifare protocol frame is transparently tunneled via the SWP protocol, that is, a Mifare frame is packed in the SWP frame as payload or useful information and is transported from a UICC to a NFC modem, or the other way round. Such a Mifare protocol frame 400 is illustrated in FIG. 5. The Mifare protocol frame includes two Mifare bytes 410 and 420 and accompanying check sums 430 and 440. Each byte 410, 420 is followed by a number or parity bits 415, 425, 435, 445. In this example, control information is present in the Mifare frame 440 illustrated in FIG. 5.

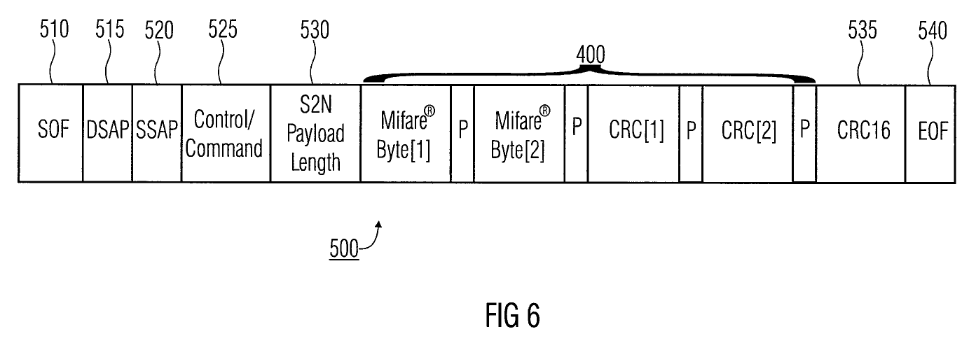

FIG. 6 shows a SWP frame 500 in which, by way of example, the Mifare frame 400 is packed, or tunneled. The SWP frame 500 contains, in the center thereof, the Mifare frame 400 around which control information of the SWP is located. In a first field 510, a SOF tag (SOF=start of frame) is sent. In both the following fields 515 and 520, the sender and receiver tags are sent (DSAP=destination service access point, SSAP=source service access point). In a field 525, control information, or control commands, of the SWP protocol can be transmitted. Here, an indication could be made, for example, indicating whether the payload of the SWP frame 500 comprises Mifare control information. The length of the SWP frame is indicated in a field 530. This field is followed by the Mifare frame 400 according to FIG. 5. A check sum 535 relating to the SWP frame 500 follows after the Mifare frame 400. At the end of the SWP frame, there is an EOF tag 540 (EOF=end of file) indicating the end of the SWP frame.

In some embodiments, it could be coded in the SWP header, or in the SWP control information, too, that the SWP payload or the SWP useful information contains a Mifare frame. In this way, the Mifare frame may be quickly submitted to a Mifare emulation. A Mifare emulation could be realized out of a state machine, for example, which could be realized in software, hardware or in a combination of both. Further, the state machine could be realized with a memory, as it is designated in FIG. 4 as Mifare FSM 350.

In another embodiment, the Mifare frame might not be indicated in the header of the SWP frame, but since Mifare frames are encoded, they would not be recognized as a valid command for a SWP instance in the usual processing, at least the possibility for this to happen would be extraordinary small. On the other hand, the frame could then be thus decoded in the Mifare FSM 350 and be recognized as a valid Mifare frame if no transmission errors are present. Thus, an identification of the Mifare frames is almost unique due to the coding. Alternatively, the recognition of Mifare frames could also be indicated by an additional information in the useful data field of the SWP, for example. In a further embodiment, a prior SWP frame might also contain an information indicating that the following SWP frames contain Mifare frames as payload, and a further SWP frame could indicate if following SWP frames no longer contain any further Mifare frames.

Thus, embodiments allow to transmit Mifare frames via a SWP and thus, to realize a broader spectrum of card emulations or card applications, for example.

In particular, it should be understood that depending on the circumstances, embodiments may also be implemented in software. The implementation may occur on a digital storage medium, in particular a disc, a CD or a DVD with electronically readable control signals which interact with a programmable computer system such that the corresponding method is executed. In general, embodiments may thus be also realized as a computer program product with a program code stored on a machine-readable carrier for performing the method, when the computer program product runs on a computer. In other words, embodiments may thus be realized as a computer program having a program code for performing the method, when the computer program product runs on a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. An apparatus for contactless transmission of data according to a predetermined transmission protocol providing control information and payload for a data transmission, comprising:
a near field communicator;
an interface connected to the near field communicator, the interface being operative to:
using a first protocol, provide data to the near field communicator for the contactless transmission, or
using the first protocol, acquire data received contactlessly from the near field communicator, the first protocol providing a transmission of control information and payload,
the payload of the first protocol including the control information and the payload of the predetermined protocol; and
a module connected to the interface and being operative to
acquire, from the payload of the first protocol, the control information and the payload of the predetermined transmission protocol for the data received contactlessly from the near field communicator or
introduce, into the first protocol, the control information and payload of the predetermined transmission protocol for the data to be transmitted contactlessly from the near field communicator.

2. The apparatus according to claim 1, wherein the near field communicator operates according to ISO 14443-3 or ISO 14443-4.

3. The apparatus according to claim 1, wherein the first protocol includes information identifying the payload as control information and payload of the predetermined transmission protocol.

4. The apparatus according to claim 3, wherein the information is included in a part of the header of a frame of the first protocol, in a part of the payload or in a prior frame as only payload.

5. The apparatus according to claim 1, wherein the first protocol is the SWP (single wire protocol).

6. The apparatus according to claim 1, wherein the predetermined protocol is the Mifare protocol.

7. The apparatus according to claim 6, wherein the predetermined protocol includes Mifare Classic, Mifare Light or Mifare Ultralight.

8. The apparatus according to claim 1, wherein the near field communicator includes an NFC modem.

9. The apparatus according to claim 1, further including a UICC comprising the interface and the module.

10. The apparatus according to claim 1, further including a UICC receiving data according to the first protocol and a chip receiving data according to the predetermined protocol, the UICC and the chip being connected to the near field communicator via the interface, and the chip including the module.

11. The apparatus according to claim 10, wherein the UICC does not react upon receipt of data according to the predetermined protocol at the near field communicator.

12. The apparatus according to claim 9, wherein the UICC is a SIM card functioning as a memory.

13. A data transmission circuit, comprising:
a transceiver module with an interface for a first protocol and an air interface; and
a memory module coupled to the interface for the first protocol and configured to acquire, from the payload of the first protocol, control information and payload of the predetermined transmission protocol for data received via the air interface or to introduce, into the first protocol, the control information and the payload of the predetermined transmission protocol for the data to be transmitted via the air interface.

14. The data transmission circuit according to claim 13, wherein the air interface operates according to ISO 14443-3 or ISO 14443-4.

15. The data transmission circuit according to claim 13, wherein the first protocol is the SWP.

16. The data transmission circuit according to claim 13, wherein the predetermined protocol is the Mifare protocol.

17. The data transmission circuit according to claim 13, wherein the transceiver module includes a NFC modem.

18. The data transmission circuit according to claim 13, wherein the memory module includes a UICC or a SIM card.

19. A Mifare emulator, comprising:
an NFC modem,
an interface connected to the NFC modem, the interface being operative to:
using the SWP data, provide data to the NFC modem for the contactless transmission, or
using the SWP protocol, acquire data received from the NFC modem;
a UICC coupled to the interface for communication via the SWP and comprising a Mifare frame state machine being operative to:
acquire, from the payload of SWP, the Mifare control information and the Mifare payload for the data received from the NFC modem, or
to introduce, into the SWP, the Mifare control information and the Mifare payload for the data to be transmitted from the NFC modem as payload.

20. The Mifare emulator according to claim 19, wherein the NFC modem is formed to communicate according to ISO 14443-3 or ISO 14443-4.

21. A method for contactless transmission of data according to a predetermined transmission protocol providing control information and payload for a data transmission, comprising:
introducing, into a first protocol, the control information and the payload of the predetermined transmission protocol for the data to be transmitted contactlessly, the payload of the first protocol including the control information and the payload of the predetermined protocol; and
using a first protocol, providing the data for the contactless transmission.

22. A method for contactless transmission of data according to a predetermined transmission protocol providing control information and payload for a data transmission, comprising:
using a first protocol, acquiring data received contactlessly, the first protocol providing a transmission of control information and payload, the payload of the first protocol including the control information and the payload of the predetermined protocol; and
acquiring, from the payload of the first protocol, the control information and the payload of the predetermined transmission protocol for the data received contactlessly.

23. The method according to claim 21, wherein the first protocol is the SWP (single wire protocol).

24. The method according to claim 21, wherein the predetermined protocol is the Mifare-protocol.

25. The method according to claim 24, wherein the predetermined protocol includes Mifare Classic, Mifare Light or Mifare Ultralight.
